(19) United States
(12) Patent Application Publication
(10) Pub. No.: US 2026/0036432 A1
(43) Pub. Date: Feb. 5, 2026

(54) SYSTEM AND METHOD FOR DETERMINING OPTIMAL ROUTE

(71) Applicant: HERE Global B.V., Eindhoven (NL)

(72) Inventor: James Adeyemi FOWE, Chicago, IL (US)

(21) Appl. No.: 18/790,948

(22) Filed: Jul. 31, 2024

(51) Int. Cl. G01C 21/34

(52) U.S. Cl. CPC G01C 21/3492

(57) ABSTRACT

Embodiments of the present disclosure disclose a system for determining an optimal route. The system obtains an origin-destination (OD) matrix comprising historical traffic values for predefined time slots for each route and generates network graphs based on the OD matrix. Each of the network graphs corresponds to one of the predefined time slots, and each of the network graphs comprise nodes, and edges having corresponding weight values. The system determines desired routes from the one or more routes based on the weight values, determines travel frequency data for each of the desired routes at least in the predefined time slots based on the network graphs; and determines a modal route based on the desired routes and the travel frequency data. Each of the desired routes is associated with one of the network graphs.

### TECHNOLOGICAL FIELD

The present disclosure generally relates to optimal route selection, and more particularly relates to systems and methods for determining optimal route for vehicle navigation.

### BACKGROUND

In urban environments, the efficiency of transportation networks plays a critical role in daily life and economic activities. With the increasing complexity of road networks and the proliferation of navigation systems, there is a growing demand for intelligent route planning solutions that can adapt to changing conditions and provide optimal travel recommendations.

Traditional navigation systems often rely on static maps and predefined routes, which may not account for traffic congestion or other dynamic factors that influence travel time and route efficiency. As a result, the traditional navigation systems fail to provide optimal route recommendation and may potentially cause delays and inconvenience to drivers.

Furthermore, drivers usually take or travel on popular route(s) based on local knowledge, convenience, or recommendation of some navigation device. However, these popular route(s) may not always be optimal and accurate. Given the dynamics of road traffic, drivers may choose inefficient routes and have significant delays and higher travel time. This may affect user experience, potentially causing user frustration. In some cases, prolonged travel time may induce stress, affect productivity of the drivers and hamper quality of life. To this end, it becomes crucial to reduce the travel times of the drivers and assist drivers in selecting the fastest and optimal routes.

### SUMMARY

To solve the foregoing problem, the present disclosure may provide a system, a method, and a computer programmable product that analyzes road traffic patterns in an origin destination (OD) matrix to determine an optimal route for navigation.

The embodiments of the present disclosure are based on an understanding that analysis of the road traffic patterns in the OD matrix may be performed to ensure that a driver takes or travels on a most efficient route.

Some embodiments of the present disclosure are based on an understanding that only current real-time traffic conditions at a time of a start of a trip are accounted or utilized for determining or selecting a route for navigation during the trip. To this end, estimated time of arrival (ETA) is determined at the start of the trip, based on the current real-time traffic conditions in one or more areas or links associated with the selected route. However, if traffic conditions change once the trip has started, the ongoing trip may get affected and driver may experience delay in reaching their destination. Further, once the trip has started, the driver may be unable to modify the route due to lack of knowledge of alternative route(s) and/or additional time for travel due to deviation from the currently travelled route. To this end, the travel time for the driver may increase due to changing traffic conditions along the route, which is not accounted for at the time of the start of the trip.

In one aspect, a system for determining an optimal route is provided. The system comprises a memory configured to store computer executable instructions, and one or more processors configured to execute the instructions. The one or more processors are configured to obtain an OD matrix associated with one or more routes. The OD matrix comprises a plurality of historical traffic values for one or more predefined time slots for each of the one or more routes. The one or more processors are configured to generate one or more network graphs based on the plurality of historical traffic values of the OD matrix. In an example, each of the one or more network graphs corresponds to one of the one or more predefined time slots, and each of the one or more network graphs comprise a plurality of nodes and a plurality of edges having corresponding weight values. The one or more processors are configured to determine one or more desired routes from the one or more routes based on the weight values. Each of the one or more desired routes is associated with one of the one or more network graphs. The one or more processors are configured to determine travel frequency data for each of the one or more desired routes at least in the one or more predefined time slots based on the one or more network graphs, and determine a modal route based on the one or more desired routes and the travel frequency data.

In additional system embodiments, the one or more predefined time slots correspond to one or more historical occurrences of a predefined time period of a day.

In additional system embodiments, each of the plurality of edges of each of the one or more network graphs is associated with one of the one or more routes. Moreover, the weight value of each of the plurality of edges is associated with historical traffic volume of a corresponding route from the one or more routes.

In additional system embodiments, the one or more routes lie between a source location and a destination location.

In additional system embodiments, the one or more processors are further configured to generate a navigation recommendation based on the modal route.

In additional system embodiments, the navigation recommendation is generated in an offline manner.

In additional system embodiments, the one or more processors are further configured to determine the one or more plurality of desired routes based on the one or more network graphs associated with the one or more predefined time slots, determine travel frequency data for each of the one or more desired routes, and determine the modal route from the one or more desired routes based on an aggregation of the one or more desired routes and the corresponding travel frequency data.

In additional system embodiments, the one or more processors are further configured to determine the one or more desired routes based on applying a shortest path function on each of the one or more network graphs.

In additional system embodiments, the one or more processors are further configured to predict, using a machine learning (ML) model, the modal route from the one or more desired routes for a future time slot associated with the one or more predefined time slots. The ML model is trained based on a plurality of training network graphs and training trip frequency data.

In additional system embodiments, a travel time associated with each of the one or more desired routes is shortest among one or more travel times associated with the one or more routes other than the one or more desired routes in a corresponding network graph from the one or more network graphs.

In additional system embodiments, the historical traffic values comprise traffic volume distribution for each of the one or more routes during the one or more predefined time slots.

In another aspect, a method for determining an optimal route is provided. The method comprises obtaining an OD matrix associated with one or more routes. The OD matrix comprises a plurality of historical traffic values for one or more predefined time slots for each of the one or more routes. The method comprises generating one or more network graphs based on the plurality of historical traffic values of the OD matrix. In an example, each of the one or more network graphs corresponds to one of the one or more predefined time slots, and each of the one or more network graphs comprise a plurality of nodes and a plurality of edges having corresponding weight values. The method comprises determining one or more desired routes from the one or more routes based on the weight values. For example, each of the one or more desired routes is associated with one of the one or more network graphs. The method comprises determining travel frequency data for each of the one or more desired routes at least in the one or more predefined time slots based on the one or more network graphs, and determining a modal route based on the one or more desired routes and the travel frequency data.

In yet another aspect, a computer program product for determining an optimal route is provided. The computer program product comprises a non-transitory computer readable medium having stored thereon computer executable instructions which when executed by at least one processor, cause the processor to conduct operations. The operations comprise obtaining an OD matrix associated with one or more routes. The OD matrix comprises a plurality of historical traffic values for one or more predefined time slots for each of the one or more routes. The operations comprise generating one or more network graphs based on the plurality of historical traffic values of the OD matrix. In an example, each of the one or more network graphs corresponds to one of the one or more predefined time slots, and each of the one or more network graphs comprise a plurality of nodes and a plurality of edges having corresponding weight values. The operations comprise determining one or more desired routes from the one or more routes based on the weight values. For example, each of the one or more desired routes is associated with one of the one or more network graphs. The operations comprise determining travel frequency data for each of the one or more desired routes at least in the one or more predefined time slots based on the one or more network graphs, and determining a modal route based on the one or more desired routes and the travel frequency data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the present disclosure in general terms, reference will now be made to the accompanying drawings, which are not necessarily drawn to scale, and wherein:

FIG. 1 illustrates a block diagram of a network environment where a system for determining an optimal route is implemented, in accordance with an embodiment of the present disclosure;

FIG. 2 illustrates a block diagram of the system of FIG. 1 for determining the optimal route, in accordance with an example embodiment of the present disclosure;

FIG. 3 illustrates an example OD matrix, in accordance with an example embodiment of the present disclosure;

FIG. 4 illustrates an example network graph, in accordance with an example embodiment of the present disclosure;

FIG. 5 illustrates an example flowchart of a method for aggregating one or more desired routes, in accordance with an example embodiment of the present disclosure;

FIG. 6 illustrates a flowchart of a method for determining an optimal route, in accordance with an example embodiment of the present disclosure;

FIG. 7 illustrates an exemplary format of map data stored in a map database, in accordance with one or more example embodiments;

FIG. 8 illustrates another exemplary format of the map data stored in the map database, in accordance with one or more example embodiments; and

FIG. 9 illustrates an exemplary map database storing map data for determining the optimal route in the form of attributes shown in FIG. 7 and FIG. 8, in accordance with one or more example embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown.

### Definitions

The term “vehicle” may refer to an autonomous, semi-autonomous or manual automotive vehicle that may use one or more motors for propulsion on or above ground surface. In an example, vehicle refers to any device or apparatus capable of transporting goods or passengers over land, water, or air. The vehicle may also extend to encompass various components, systems, and accessories associated with transportation devices, such as propulsion systems, control mechanisms, navigation systems, safety features, energy storage devices, and communication systems. Generally, a vehicle may encompass a wide range of transportation means, including but not limited to, land vehicles, aircraft, and watercraft. While the embodiments of the present disclosure are described with regard to the vehicle being a land vehicle, this should not be construed as a limitation. Implementation of the embodiments of the present disclosure to other types of vehicles may be apparent to a person skilled in the art.

The term “route” may refer to a predefined path or a sequence of spatial waypoints that connect an origin location to a destination location within a transportation network. In an example, the route may represent a specific journey or itinerary for traveling between two or more points of interest, typically optimized for efficiency, safety, and convenience.

In certain cases, the route may consist of a series of interconnected segments, such as roads, highways, streets, or pathways, each with its own geographic coordinates and attributes. These segments are selected based on criteria such as distance, travel time, traffic conditions, road quality, and user preferences. For example, the route may be generated by navigation systems or route planning algorithms, which may analyze geographic data, real-time traffic information, and user input to determine an optimal path for reaching the destination. The selected route may vary depending on factors such as mode of transportation, time of day, weather conditions, and specific user preferences or constraints.

The term “network graph” may refer to a graph model that maps connectivity between various locations within a transportation network. In an example, the network graph may be a mathematical representation of a transportation network consisting of a plurality of nodes and a plurality of edges. The plurality of nodes may represent specific locations or points of interest, such as intersections, landmarks, origins, or destinations. Moreover, the plurality of edges may represent connections or paths between these locations. In this manner, the network graphs are used to model road networks, public transit systems, or other transportation infrastructure. Techniques used to generate the network graph may include, but are not limited to, tree graph, directed graph, undirected graph, complete graph, weighted graph, bipartite graph, sparse graph, and dense graph.

The term “modal route” refers to a specific route such that the specific route is the most efficient or advantageous path between an origin and a destination. For example, the specific route may be generated based on certain criteria or objectives, such as to minimize travel time, distance, cost, or other relevant factors, while maximizing safety, convenience, or user preferences.

### End of Definitions

When a user or a driver begins to travel to their destination location from a source location, the user may use local knowledge or navigation applications for ease of travelling. Navigation applications have revolutionized the way people navigate and travel, offering convenient and user-friendly solutions for finding directions, estimating travel times, and avoiding traffic congestion.

However, despite their widespread adoption and popularity, navigation applications have certain limitations. In particular, the navigation applications fail to predict the fastest route as well as may fail to predict travel times accurately.

Some embodiments of the present disclosure are based on a recognition that the navigation applications may utilize real-time traffic on one or more routes between a source location and a destination location at a start of a trip to predict a travel route for travelling from the source location to the destination location. Subsequently, as the trip progresses, the predicted travel route may not remain fastest or optimal route owing to dynamic traffic conditions. In certain cases, due to changes in traffic conditions across the one or more routes, the travel time predicted at the start of the trip for the predicted travel route may change, for example, may get prolonged causing delays. This may negatively affect the reliance of the user on the navigation applications. Moreover, the user may fail to optimally travel (such as, within optimal time or in fastest manner) from the source location to the destination location.

Various embodiments are provided herein for determining an optimal route for navigation based on analyzing historical traffic patterns. This may enable the user to choose an optimal path for navigation between the source location and the destination location. In this regard, historical OD matrix or matrices are analyzed to study historical trips between the source location and the destination location during different historical time slots. Subsequently, an optimal route for a trip is predicted based on the historical traffic patterns to ensure that the most efficient and/or fastest route is provided to the user for their trip based on the time of the trip. Based on the analysis of the historical traffic patterns, route recommendation is provided, and navigation systems may be improved. In certain cases, the route recommendation provided using the system of the present disclosure may be used efficiently in offline routing as well.

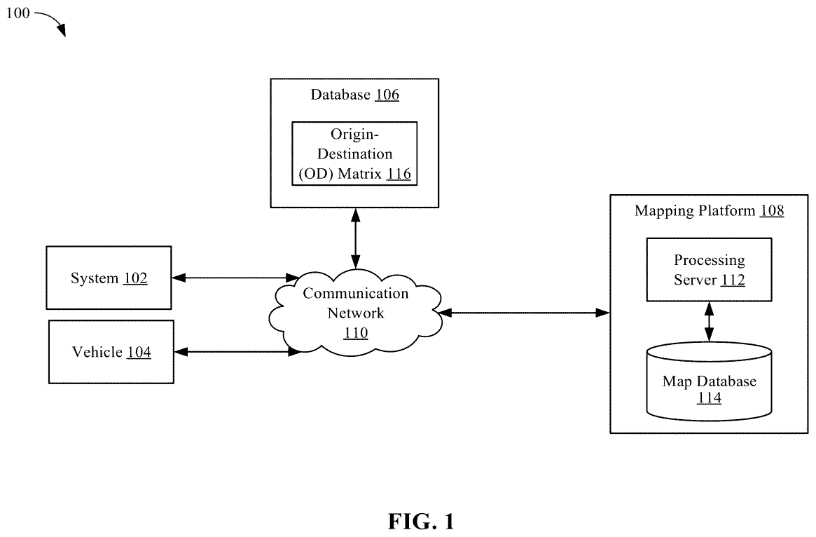

FIG. 1 illustrates a block diagram of a network environment 100 comprising a system 102 implemented for determining an optimal route for vehicle navigation, in accordance with an example embodiment. In an example, a user may want to travel from a source location to a destination location, for example, using their vehicle 104. In an example, the source location and the destination location may be within a geographical area, such as a locality, a city, a state, or a country. Examples of the vehicle 104 may include, but is not limited to, a two-wheeler, a cycle, a car, a bus, a truck, etc.

Embodiments of the present disclosure provide techniques to accurately predict the optimal route for navigation between the source location and the destination location. The optimal route (also referred to as a modal route, hereinafter) is predicted based on historical traffic information and historical traffic patterns to ensure that the most efficient route identified in historical data is selected as the optimal route. Based on the consideration of the historical traffic patterns for predicting the optimal route, the dependency for predicting the optimal route is not set merely on real-time traffic on the route at the time of the start of the trip. Instead, the embodiments of the present disclosure aim to determine optimal route(s) between the source location and the destination location during different time periods of the days based on the analysis of the historical traffic patterns and the historical traffic conditions. In this manner, expected traffic conditions when the vehicle reaches various parts or segments of the route are predicted based on corresponding time. This may enable us to accurately forecast expected traffic along each of the routes between the source location and the destination location. Subsequently, an optimal route from multiple routes between the source location and the destination location is selected to ensure that the user travels on the most efficient route.

In an example, the system 102 may be coupled with the vehicle 104, a database 106 and/or a mapping platform 108, via a communication network 110. In an embodiment, the system 102 may be coupled to one or more communication interfaces, for example, as a part of a routing system, a navigation app, and the like.

All the components in the network environment 100 may be coupled directly or indirectly to the communication network 110. The components described in the network environment 100 may be further broken down into more than one component and/or combined together in any suitable arrangement. Further, one or more components may be rearranged, changed, added, and/or removed. In an example embodiment, the system 102 may be a processing server 112 of the mapping platform 108 and therefore may be co-located with or within the mapping platform 108. In accordance with an embodiment, the database 106 may be a map database 114 of the mapping platform 108 and therefore may be co-located with or within the mapping platform 108. The database 106 may be configured to receive, store, and transmit data that may be collected from vehicles or from a database associated with a user who is using or driving vehicles. The system 102 may comprise suitable logic, circuitry, and interfaces that may be configured to determine an optimal route for navigation.

In operation, the system 102 is configured to obtain an OD matrix 116 associated with one or more routes. In an example, the one or more routes may lie between a source location and a destination location. The OD matrix 116 comprises a plurality of historical traffic values for one or more predefined time slots for each of the one or more routes. In an example, the one or more routes (referred to as routes, hereinafter) are associated with a geographic area, such as a city. Subsequently, the routes may include travel paths for travelling from one location, i.e., the source location, to another location, i.e., the destination location within the geographic area. Each of the routes or travel paths may include a plurality of interconnected link segments, wherein one or more link segments may overlap in at least some of the routes.

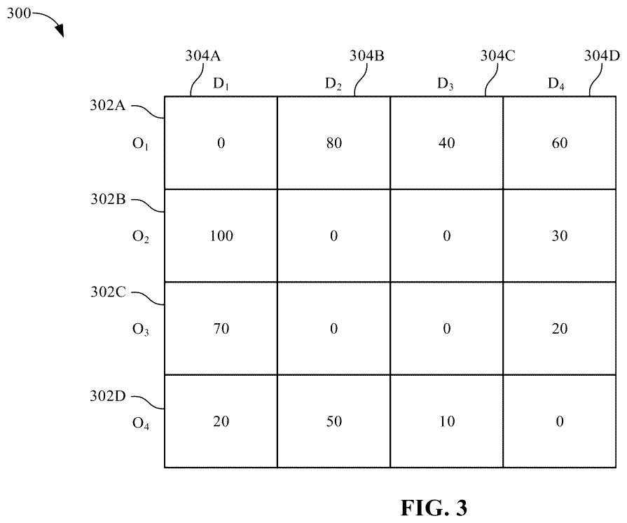

In particular, the OD matrix 116 may represent historical traffic values for each of the routes during each of the one or more predefined time slots. A historical traffic value for a route may indicate a number of trips performed or a number of vehicle(s) that travelled through the route during a period of time, such as a time period in a day, an entire day, etc. The period of time to which the historical traffic value corresponds is referred to as a time slot. Particularly, the time slot is a historical occurrence of a period of time of a day, i.e., a time window that has already happened or occurred in past day or in past time. Details of the OD matrix 116 are further described in conjunction with, for example, FIG. 3.

Further, the system 102 is configured to generate one or more network graphs based on the plurality of historical traffic values of the OD matrix 116. In an example, a plurality of or multiple network graphs may be generated based on different sets of values from the historical traffic values. For example, each of the network graphs corresponds to one of the one or more predefined time slots. In other words, each of the network graphs may correspond to a predefined time slot, for example, 9:00 AM to 9:30 AM, of different days, such as Mondays, Tuesdays, Wednesdays, etc. In another example, each of the network graphs may correspond to a predefined time slot, such as 9:00 AM to 9:30 AM of a same day, such as Mondays, of different weeks of a month or a number of months. In certain cases, a network graph may correspond to traffic volume across an entire day, such as a previous day, a day before yesterday, etc. In this manner, different network graphs may correspond to different time slots of the same day or the different days. In an example, the network graph may be a directed acyclic graph (DAG), or a tree graph.

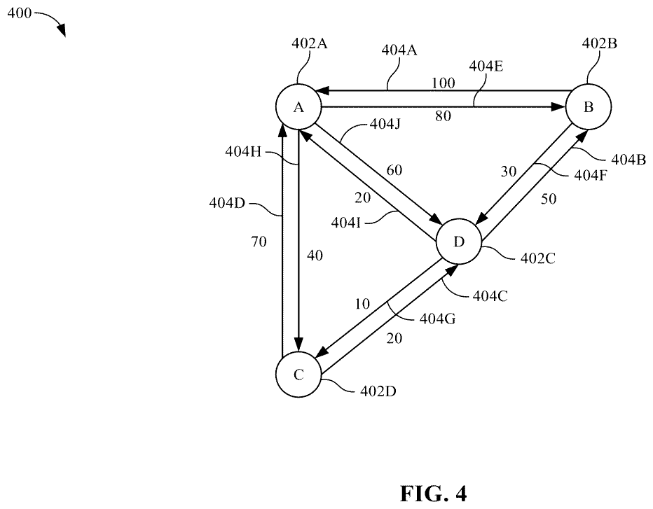

Moreover, each of the one or more network graphs comprises a plurality of nodes and a plurality of edges having corresponding weight values. For example, each of the plurality of nodes may be indicative of or may correspond to a geographical location or a geographical zone within the geographic area that may lie enroute the source location and the destination location. Subsequently, the nodes may correspond to, for example, a geographical coordinate, a point of interest, an intersection, a link segment, etc. Further, an edge may connect two nodes. The edge may indicate a route, a travel path or a link segment between the geographical locations indicated by the two nodes. In an example, the edge may indicate a travel path that may be a part of a route between the source location and the destination location. Alternatively, the edge may indicate a route between the source location and the destination location. Moreover, the weight value of the edge may indicate traffic volume, particularly historical traffic value, associated with a route, a travel path or a link segment indicated by the edge. For example, the weight value of the edge is based on the historical traffic value for an OD pair associated with the edge in the OD matrix 116. Details of the network graph are further described in conjunction with, for example, FIG. 4.

Thereafter, the system 102 is configured to determine one or more desired routes from the one or more routes based on the weight values. In an example, each of the one or more desired routes is associated with one of the one or more network graphs. For example, the weight value of each edge in a network graph is compared to determine a desired route for the network graph. For example, if each edge of the network graph corresponds to a route between the source location and the destination location, then an edge having, for example, lowest weight, may be selected as a desired route for network graph. Alternatively, if each edge of the network graph corresponds to travel path or a link segment, then a weight for a route between the source location and the destination location may be determined based on an aggregation of weights of edges forming the route. Subsequently, the aggregated weights for the routes may be compared to determine the desired route for the network graph.

The system is further configured to determine travel frequency data for the desired routes at least in the one or more predefined time slots based on the network graphs. Once the desired routes are identified from each of the corresponding network graphs, the travel frequency data, i.e., a frequency of trips or a number of trips performed between the source location and the destination location using each of the desired routes in a particular duration is determined. In an example, the travel frequency data is determined based on the weight values of the edges of the network graphs. In an example, a travel frequency for a desired route may indicate a number of trips that happened between the source location and the destination location using the desired route in at least historical occurrences of the particular time period, say 9: 00AM to 9:30 AM, on a specific day or all the past days.

The system is configured to determine a modal route based on the desired routes of each of the network graphs and the travel frequency data. In an example, the modal route is an optimal route that ensures efficient navigation during a time period associated with the one or more predefined time slots. In an example, a modal function may be used to determine the modal route. For example, the modal function is utilized to determine a route having highest frequency of being used for travelling from the source location to the destination location during the particular time period associated with the predefined time slots. Such a determined route is identified as the modal route. The modal route is then used for providing navigation instructions to the vehicle 104 travelling from the source location to the destination location during a time period, such as a future occurrence of a time period associated with the predefined time slots. For example, the modal route is determined as the optimal route for 9:00 AM to 9:30 AM on Monday. In such a case, the modal route may be provided as a navigation recommendation to the vehicle 104 travelling to the destination location from the source location during 9:00 AM to 9:30 AM of a present or a future Monday.

In an example, the modal route may be stored as a fastest or efficient or optimal route pattern for travelling from the source location to the destination location for the time period of 9: 00AM to 9:30 AM. The modal route may then be used for both online and offline route and navigation recommendations when a driver wants to navigate from the source location to the destination location during the time period to achieve efficient and fastest trip.

Although the embodiments of the present disclosure describe the one or more routes to be between the source location and the destination location, this should not be construed as a limitation. For example, the OD matrix 116 may correspond to a plurality of routes in the geographic area, such as a city or a state, etc. Subsequently, the OD matrix 116 may include historical traffic values for each travel path across the geographic area thereby enabling optimal route determination for different pairs of source location and destination location and during different time periods, such as different days or weeks.

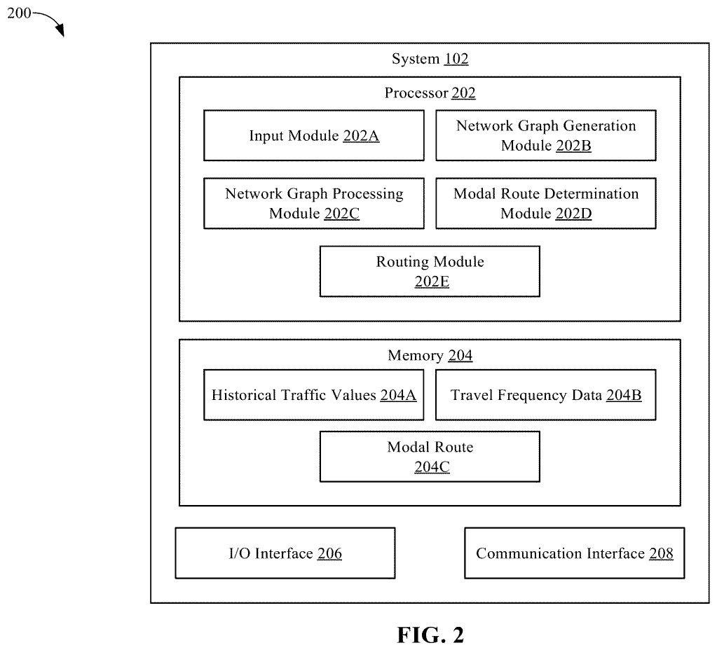

FIG. 2 illustrates an exemplary block diagram 200 of the system 102, in accordance with one or more example embodiments. FIG. 2 is explained in conjunction with FIG. 1.

The system 102 may include at least one processor (referred to as a processor 202, hereinafter), at least one non-transitory memory (referred to as a memory 204, hereinafter), an input/output (I/O) interface 206, and a communication interface 208. The processor 202 may further include an input module 202A, a network graph generation module 202B, a network graph processing module 202C, a modal route determination module 202D, and a routing module 202E. The memory 204 may further include historical traffic values 204A and travel frequency data 204B from the OD matrix 116. The memory 204 may also store a modal route 204C and other information or data that may be generated by the system 102 or the processor 202 during its operation.

The processor 202 may be connected to the memory 204, the I/O interface 206, and the communication interface 208 through one or more wired or wireless connections. Although in FIG. 2 it is shown that the system 102 includes the processor 202, the memory 204, the I/O interface 206, and the communication interface 208, however, the disclosure may not be so limiting and the system 102 may include fewer or more components to perform the same or other functions of the system 102.

The processor 202 of the system 102 may be configured to perform one or more operations associated with determining the modal route 204C for the vehicle 104. The processor 202 may be embodied as one or more of various hardware processing means such as a coprocessor, a microprocessor, a controller, a digital signal processor (DSP), a processing clement with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the system 102.

For example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202.

The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the system 102 to carry out various operations in accordance with embodiments of the present disclosure. For example, the memory 204 may be configured to buffer input data for processing by the processor 202. As exemplified in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an Application Specific Integrated Circuit (ASIC), Field Programmable Gate Array (FPGA), or the like, the processor 202 may be specifically configured hardware for conducting the operations described herein. In an embodiment, the memory 204 may be configured to store the historical traffic values 204A of the OD matrix 116 and the travel frequency data 204B and the modal route 204C, among other data, generated during execution of the operations or instruction by the processor 202 for determining the modal route 204C.

In some example embodiments, the I/O interface 206 may communicate with the system 102 and display and input and/or output devices, such as the keyboard and mouse of the system 102. As such, the I/O interface 206 may include a display and, in some embodiments, may also include a keyboard, a mouse, a touch screen, touch areas, soft keys, or other input/output mechanisms. In one embodiment, the system 102 may include a user interface circuitry configured to control at least some functions of one or more I/O interface elements such as the display and, in some embodiments, a plurality of speakers, a ringer, one or more microphones and/or the like. The processor 202 and/or I/O interface 206 circuitry including the processor 202 may be configured to control one or more operations of one or more I/O interface elements through computer program instructions (for example, software and/or firmware) stored on the memory 204 accessible to the processor 202.

The communication interface 208 may include the input interface and output interface for supporting communications to and from the system 102 or any other component with which the system 102 may communicate. The communication interface 208 may be any means such as a device or circuitry embodied in either hardware or a combination of hardware and software that is configured to receive and/or transmit data to/from a communications device in communication with the system 102. In this regard, the communication interface 208 may include, for example, an antenna (or multiple antennae) and supporting hardware and/or software for enabling communications with a wireless communication network. Additionally, or alternatively, the communication interface 208 may include the circuitry for interacting with the antenna(s) to cause transmission of signals via the antenna(s) or to manage receipt of signals received via the antenna(s). In some environments, the communication interface 208 may alternatively or additionally support wired communication. As such, for example, the communication interface 208 may include a communication modem and/or other hardware and/or software for supporting communication via cable, digital subscriber line (DSL), universal serial bus (USB), or other mechanisms.

The communication interface 208 of the system 102 may be used to access a communication network, such as the communication network 110 shown in FIG. 1. The communication network 110 may include a communication medium through which the system 102 and, for example, the database 106 and the mapping platform 108, may communicate with each other. The communication network 110 may be one of a wired connection or a wireless connection. Examples of the communication network 110 may include, but are not limited to, the Internet, a cloud network, a Wireless Fidelity (Wi-Fi) network, a Personal Area Network (PAN), a Local Area Network (LAN), or a Metropolitan Area Network (MAN). Various devices in the network environment 100 may be configured to connect to the communication network 110 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), a device to device communication, cellular communication protocols, and Bluetooth (BT) communication protocols.

In one embodiment, the processor 202 may include the input module 202A. The input module 202A may be configured to receive, obtain, or retrieve input data. In an example, the input data may be received from, for example, the database 106, and/or other databases associated with the system 102, a user of the system 102, one or more sensors of vehicles, a navigation or delivery operation service provider, etc.

Pursuant to the present disclosure, the input data includes the OD matrix 116. The OD matrix 116 may include the historical traffic values 204A associated with one or more routes, such as the routes between the source location and the destination location. The historical traffic values 204A may indicate historical traffic volume on each of the routes during a time slot from one or more predefined time slots.

The present disclosure is exemplarily described with respect to determining an optimal modal route from the routes between the particular source location and the destination location. As may be understood, such source location and destination location may be any geographical location within a geographic area accessible through a network of interconnected road segments and/or link segments. Moreover, the historical traffic values 204A for each of the routes are described to correspond to the predefined time slots, i.e., historical occurrences of a predefined time period of a day. For example, the predefined time slots may be associated with historical occurrences of a time period of 9:00 AM to 9:30 AM of every day of a week for a month or a number of months. Subsequently, the modal route is determined for the predefined time slots, 9:00 AM to 9:30 AM. However, it may be understood that in other embodiments the present disclosure may be used to determine modal routes for any other time period or any other occurrence of another time slot, such as 12: 00AM to 12:30 AM, 6:00 PM to 6:30 PM, etc. of a day.

Continuing with the present example, the input data obtained by the input module 202A may include the OD matrix 116 associated with the routes. The historical traffic values 204A may indicate a traffic volume or a number of trips that happened on each of the routes during the predefined time slots, for example, 9: 00AM to 9:30 AM of each of past days of a month or a number of months, say three months. In other embodiments, the OD matrix 116 may also include historical traffic values corresponding to other time slots of the day for each day of the past 3 months.

The processor 202 is configured to generate network graphs based on the historical traffic values 204A. In an example, the network graph generation module 202B is configured to generate the network graphs corresponding to each of the predefined time slots. In an example, each of the generated network graphs may correspond to a time slot, i.e., 9:00 AM to 9:30 AM of a day for each of the past days for three months. In this manner, multiple network graphs are generated for the historical occurrence of the time period of 9:00 AM to 9:30 AM.

Further, the processor 202 is configured to determine one or more desired routes for each of the network graphs. In an example, the network graph processing module 202C is configured to determine the desired routes from the routes between the source location and the destination location. For example, the network graph processing module 202C is configured to determine the desired route in each of the network graphs based on a weight value of each of the edges in the network graphs.

In an example, the processor 202 or the network graph processing module 202C may apply a shortest path function and/or fastest route algorithm onto each of the network graphs to determine the corresponding desired routes. The shortest path function is a mathematical algorithm or computational method used to find the most efficient or shortest path between two nodes in a network graph. The shortest path function is used to determine a route with minimum cost or distance required to travel from an origin node, i.e., the source location, to a destination node, i.e., the destination location, within the given network graph. Examples of the shortest path function may include, but are not limited to, Dijkstra's algorithm and A* algorithm. These shortest path function may evaluate the edges and the nodes of each of the network graphs based on certain criteria, such as weight values of the edges, to determine the desired routes between the origin node and the destination node in each of the network graphs.

As may be understood, the weight value of an edge of a network graph may represent a trip volume, i.e., a number of trips made using a path indicative of the edge. Such information is used to check which path(s) in the routes are most congested. For example, if a path falls on a shortest route between the source location and the destination location but has high weight value, i.e., high traffic volume, then it may be a congested path and should be avoided if a user wants to travel on a least congested and/or a fastest route. To this end, based on the weight value of each of the edges in the network graph, the weightage of each of the routes may be determined as multiple edges may form a route between the source location and the destination location. Subsequently, a desired route is selected from the routes based on, for example, the fastest travel time. In certain other cases, the desired route may also be selected based on, for example, shortest distance, scenic route, least congested, most efficient, safest, etc.

In an example, the weight values may also be indicative of link speeds and/or arc costs associated with the corresponding path. Subsequently, based on the weight values in the network graphs for 9:00 AM to 9:30 AM for previous days or weeks, the desired routes for the past days or weeks are determined. The network graphs are generated based on real-time historical traffic values of past day(s) and week(s). Therefore, the desired routes are preferred routes of drivers travelling along the routes during that particular time period of the day.

In an example, the desired routes may correspond to the time period of 9:00 AM to 9:30 AM of the day. For example, the different desired routes from the network graphs may be historical desired routes for the time period 9:00 AM to 9:30 AM. Such desired routes in each of the network graphs may be aggregated for trips over 3 months at the time period 9:00 AM to 9:30 AM of a day or a day of a week. These aggregated routes may form a cluster of desired or fastest routes in the network graphs where t=time of the week, i.e., 9:00 AM to 9:30 AM of a day or 9:00 AM to 9:30 AM of a Monday.

Thereafter, the processor 202 is configured to determine the travel frequency data 204B for each of the desired routes at least in the one or more predefined time slots based on the network graphs. In an example, the processor 202 is configured to determine frequency of trips in each of the desired routes, i.e., which of the desired routes has been taken, chosen, or travelled on with more frequency. This may indicate historical user preferences in route selection as well as how good or bad the historical decision has been, i.e., if there were any delays, if they encountered any accident, etc.

Based on the desired routes and the travel frequency data 204B, the processor 202 is configured to determine the modal route 204C. In an example, the modal route determination module 202D is configured to determine the modal route 204C from the desired routes using a modal function. The modal function may be used to obtain the modal route 204C having the highest frequency among other desired routes. In an example, the modal function is configured to apply a mathematical function to a dataset of travel frequency values corresponding to the desired routes. The travel frequency value for a desired route may indicate the number of times that users or vehicles chose the particular desired route for travelling at least from the source location to the destination location. For example, a first desired route, a second desired route, a third desired route and a fourth desired route may have travel frequency values as, for example, 150, 248, 520, 362. In such a case, the third desired route having the highest frequency may be selected as the modal route 204C.

In an example, the determined modal route 204C may be stored as a fastest route pattern between the source location and the destination location for future time slots or future occurrences of the time period of 9:00 AM to 9:30 AM. Such stored modal route 204C may then be used to enable navigation of the vehicle 104 in online and offline manner to achieve fastest trip in the time period.

In an example, the processor 202 may utilize a machine learning (ML) model to determine the modal route 204C. In an example, the ML model may be used by the processor 202 to predict the modal route 204C from the one or more desired routes for a future time slot associated with the one or more predefined time slots. For example, the ML model is trained based on a plurality of training network graphs and training trip frequency data.

In an example, the network graph processing module 202C and the modal route determination module 202D may be ML-based models. The ML model may perform analysis of the network graphs to identify the desired routes, for example, fastest routes, in each of the network graphs. Further, based on the desired routes and the travel frequency data 204B, the modal route 204C is identified or determined. In certain cases, the ML model may continually or periodically re-determine the modal route 204C based on newly received historical traffic values or historical traffic data associated with the routes.

Further, the processor 202 may also be configured to generate a navigation recommendation based on the modal route 204C. In an example, the modal route 204C may be fed to the routing module 202E. The routing module 202E may be configured to generate user readable or user-understandable navigation instructions, such as routing messages, notifications, warning messages, etc., to provide navigation recommendation based on the modal route 204C. The routing module 202E may send or push the routing messages to user equipment, such as user equipment on-board the vehicle 104 to enable a user or a driver of the vehicle 104 to travel via the modal route 204C ensuring fastest travel time. The routing module 202E may also send or push routing messages to other user equipment associated with the vehicle 104 or other vehicle that may have to travel between the source location and the destination location during the time period.

In an example, the navigation instructions are generated in an offline manner. Offline navigation allows users or drivers to navigate without an active internet connection by utilizing pre-downloaded maps and routing data stored locally on their user device. In an example, map data may be downloaded for the specific geographic area, such as region, city or country associated with the source location and the destination location onto the user device. The pre-downloaded map data may include detailed information about road segments, link segments, landmarks, points of interest, and other relevant geographical features. The downloaded map data is stored locally on the device's memory or SD card, allowing users to access and use the maps without requiring an internet connection. Further, the stored modal route 204C for travelling from the source location to the destination location may be used to provide most efficient navigation path for the user. In an example, global positioning system (GPS) receiver in the user device may be used to track coordinates of the user or the driver of the vehicle 104 and provides turn-by-turn navigation instructions to guide the user along the modal route 204C.

In an example, the navigation recommendation for the modal route 204C may be dynamically adjusted to provide real-time feedback on traffic condition of the modal route 204C, including aspects such as congestion, average speed, predicted condition etc.

FIG. 3 illustrates an example OD matrix 300, in accordance with an example embodiment of the present disclosure. The OD matrix 300 may refer to a matrix that may indicate flow of trips between various origin and destination pairs within a given geographic area. The OD matrix 300 may be a square matrix that quantifies volume of trips between all pairs of origins (i.e., origin zones or origin locations) and destinations (i.e., destination zones or destination locations) within a transportation network.

In an example, each cell of the OD matrix 300 may represent a number of trips or the flow of goods, people, or vehicles moving from an origin to a destination. For example, rows (depicted as rows 302A, 302B, 302C and 302D) of the OD matrix 300 may represent the origins. As shown, a row 302A represents origin O₁, a row 302B represents origin O₂, a row 302C represents origin O₃, and a row 302D represents origin O₄. Further, columns (depicted as columns 304A, 302b, 302c and 302c) of the OD matrix 300 may represent the destinations. As shown, a column 304A represents destination D₁, a column 304B represents destination D₂, a column 304C represents destination D₃, and a column 304D represents destination D₄.

In navigation and transportation planning, OD matrices may be used to understand travel patterns, predict traffic flows, optimize route selection, guide infrastructure investments, and evaluate transportation policies.

Pursuant to present disclosure, the OD matrix 300 comprises historical traffic values. For example, the OD matrix 300 is associated with a geographic area and includes historical traffic values 204C for an historical occurrence of a time period, such as a historical occurrence of 9:00 AM to 9:30 AM. The historical traffic values are depicted as values 0, 80, 40 and 60 in the row 302A; 100, 0, 0 and 30 in the row 302B; 70, 0, 0 and 20 in the row 302C; and 20, 50, 10 and 0 in the row 302D. These historical traffic values may indicate a trip volume or a number of vehicles that travelled through a corresponding origin-destination pair during a time slot. For example, a historical traffic value or a trip volume between O₂ and D₁ is 100. Subsequently, each of the historical traffic values may correspond to historical traffic flow or historical volume of trips between all the pairs of origins and destinations within the transportation network. For example, the historical traffic values may be volume of trips across a predefined time period in a day, a day, a number of days, a predefined time period for a number of days, etc.

Pursuant to the present disclosure, the OD matrix 300 includes a plurality of historical traffic values for one or more predefined time slots. In an example, the historical traffic values may indicate real-time traffic at the routes during the one or more historical predefined time slots, such as a time slot of a day previous to a current day, or a time slot of a day in a previous week, etc. For example, a historical traffic value for a route may indicate a number of trips or a trip volume that may have occurred through the route in one of the predefined time slots.

In an example, the one or more predefined time slots correspond to one or more historical occurrences of a predefined time period of a day. For example, the predefined time period of the day may be a particular time period on a particular day, such as 9: 00AM to 9:30 AM on Monday. Subsequently, the one or more predefined time slots may correspond to 9:00 AM to 9:30 AM on a day, such as every Monday of a month or a predefined number of months, or a year, or a predefined number of years. To this end, the historical traffic values may include trip volume or number of trips for each of the routes during each of the predefined time slots, such as during the time slots of 9: 00AM to 9:30 AM on Monday(s) for a month or a number of months, say 3 months. It may be understood that such examples of the predefined time slots as a particular time period, i.e., 9: 00AM to 9:30 AM, of the day, i.e., Monday, is only exemplary and should not be construed as a limitation.

For example, the OD matrix 300 may also include historical traffic values corresponding to different time slots, such as 12:00 AM to 12:30 AM, . . . , 5:00 AM to 5:30 AM, 6:00 AM to 6:30 AM, 6:30 AM to 7:00 AM, . . . 12:30 PM to 1:00 PM, 1:00 PM to 1:30 PM, . . . , 11:30 PM to 12:00 AM for each of different days of the week. Further, the predefined time slots to be 30 minutes is only exemplary and should not be construed as a limitation. In other examples, the predefined time slots may be 1 minute, 5 minutes, 10 minutes, 15 minutes, 20 minutes, 45 minutes, 60 minutes, and the like. Further, the OD matrix 300 may include historical traffic values for different time slots for each of the different days for each of the routes within the geographical arca.

FIG. 4 illustrates an example network graph 400, in accordance with an example embodiment. The network graph 400 includes nodes (depicted as node 402A, node 402B, node 402C, and node 402D, and collectively referred to as nodes 402). The network graph 400 may also include edges (depicted as edge 404A, edge 404B, edge 404C, edge 404D, edge 404E, edge 404F, edge 404G, edge 404H, edge 404I, and edge 404J, and collectively referred to as edges 404). Further, the weight value of each of the edges 404 is based on the historical traffic values in the OD matrix 300.

In an example embodiment, the node 402B may be a source node corresponding to an origin, such as the origin O₂ and the node 402A may be a destination node corresponding to a destination, such as the destination D₁. Further, in the example illustrated in FIG. 4, there exist two routes between the source node 402B and the destination node 402A. A first route may include a travel path indicated by the edge 404A, while a second route may include a travel path indicated by an aggregation of the edge 404F and the edge 404I. Subsequently, the weightage of the first route may be based on the weight value of the edge 404A, i.e., 100, while a weightage of the second route may be a summation or aggregation of weight values 30 and 20 for the edge 404F and the edge 404I, respectively.

For example, the weightage of the first route is higher than the weightage of the second route. Subsequently, the second route may be selected as the desired route for the network graph 400 based on a fastest route criterion. Alternatively, the first route may be selected as the desired route for the network graph 400 based on a shortest route criterion. In an example, the desired route determined for the network graph 400 may indicate most efficient and/or fastest route from the first route and the second routes between the source node 402B and the destination node 402A between a time period of, for example, 9:000 AM to 9:30 AM

The network graph 400 may be associated with one of the predefined time slots, i.e., a historical occurrence of the predefined time period of 9:00 AM to 9:30 AM. Further, for example, the second route may be faster than the first route. Subsequently, the second route may be determined as the desired route. In this manner, different network graphs may be generated for the different historical occurrences of the predefined time period across the different days. Further, the network graphs may include the same nodes 402 and the edges 404, however, weight values of the edges 404 may change in the different network graphs. The desired route may be determined based on the weight values of the edges 404 for each of the network graphs.

In an example, each of the plurality of edges 404 of each of the network graphs is associated with one of the one or more routes. For example, an edge may form a route or a part of a route. Moreover, the weight value of each of the plurality of edges 404 is associated with historical traffic volume of a corresponding route from the one or more routes.

In an example, the desired routes from the network graphs are aggregated. Details of the aggregation are described in conjunction with the FIG. 4.

Based on the desired routes for different network graphs, the modal route 204C is determined. For example, for travel between the source node 402B and the destination node 402A, the first route and the second route may exist. A number of network graphs may be generated for different time slots relating to the same or different historical time periods. From each of the number of network graphs, a desired route is determined. For example, each of the network graphs may correspond to a time slot, such as 9:00 AM to 9:30 AM on a day, such as Monday or a previous day. Subsequently, there may exist multiple network graphs for historical occurrence of a same time period, such as 9:00 AM to 9:30 AM on a Monday from different past week's data. Subsequently, a desired route in each of these network graphs for 9:00 AM to 9:30 AM on a Monday may be a route enabling most efficient and/or fastest navigation during this time slot on corresponding particular day of the week.

Further, based on a frequency of the different desired routes, a route having highest frequency is determined as a modal route for travelling from the source location corresponding to the source node 402B to the destination location corresponding to the destination node 402A, such as for a time period of 9:00 AM to 9:30 AM.

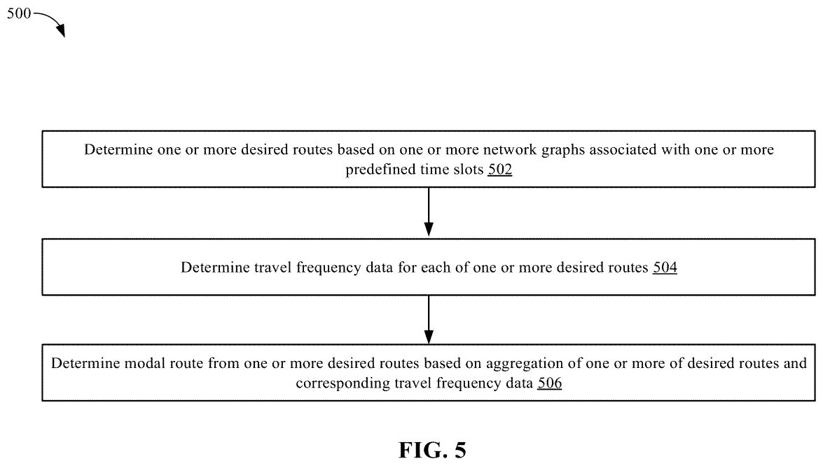

Referring to FIG. 5, there is shown a flowchart 500 of a method for aggregating desired routes, in accordance with an example embodiment. The steps of the flowchart 500 may be performed by the processor 202 or the system 102.

At 502, one or more desired routes are determined based on one or more network graphs associated with the one or more predefined time slots. For example, the one or more predefined time slots may be associated with 9:00 AM to 9:30 AM on each day of a historical month, a historical week, or an ongoing week. Based on real-time traffic data of the routes during the historical one or more predefined time slots, a network graph for each of the one or more predefined time slots is generated. Then, a desired route is determined for each of the network graphs. Subsequently, the desired routes may correspond to different time slots, i.e., different historical occurrences of a time period across different days of week(s) or month(s).

At 504, travel frequency data 204B is determined for each of the plurality of desired routes. The travel frequency data may indicate a number of trips, i.e., how many people preferred to travel using a particular desired route, for each of the desired routes across a historical time period or each of the predefined time slots.

Thereafter, at 506, the modal route 204C is determined from the plurality of desired routes based on an aggregation of the plurality of desired routes and the corresponding travel frequency data.

In an example, the desired routes may be shortest routes and/or fastest routes in corresponding network graphs at a time period t associated with the predefined time slots. Moreover, multiple desired routes may be determined within a network graph corresponding to city-wide transportation network, such that the multiple desired routes may be associated with different or at least partially different origin-destination or source-destination pairs. For example, based on the desired routes in the network graphs, modal routes for city-wide efficient navigation during the time period id determined. The modal routes may be aggregated to form a cluster of fastest and/or most efficient routes in the city during the time period or future occurrence of the time period of the week, say 9:00 AM to 9:30 AM of Monday.

In this regard, median travel times (TT) of each of the desired routes are determined or obtained. Further, a median of all the median travel times of all aggregated desired routes are determined. Further, the modal route 204C or modal fastest route is determined by checking the sequence of links forming the routes to ascertain which route is most frequently travelled. The modal route 204C is determined based on identifying a route from the desired routes that occurs the most frequent amongst the aggregated fastest routes.

In an example, an estimated travel time of the modal route 204C is obtained or determined. In this regard, a means of travel times of each of the desired routes is determined. In an example, travel time of each trip across a desired route of a network graph is obtained. Further, a means of travel times is determined. The mean may indicate estimated travel time for the desired route during a predefined time slot. In this manner, the means of travel times may be determined for different desired routes. Further, once the modal route 204C is determined from the desired routes, an estimated travel time for the modal route 204C is predicted based on the mean travel time for the desired route selected as the modal route 204C.

Further, all information relating to the network graph, the desired routes, the modal route 204C and the travel times may be stored in database 106 to be used for providing navigation recommendation and/or navigation instructions.

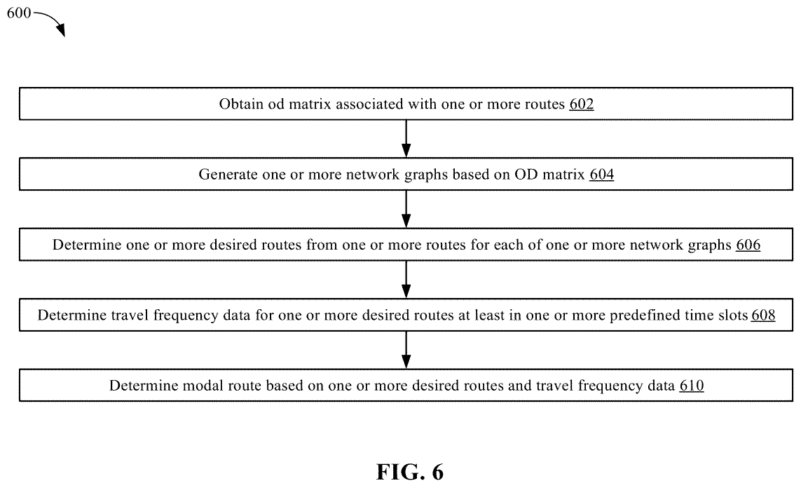

FIG. 6 illustrates a flowchart 600 of a method for determining an optimal route, in accordance with an example embodiment. The steps of the flowchart 600 may be performed by the processor 202 or the system 102.

At 602, the OD matrix 116 associated with one or more routes is received. In an example, the input module 202A is configured to receive or retrieve the OD matrix 116 from the database 106. The OD matrix 116 comprises the plurality of historical traffic values 204A for one or more predefined time slots for each of the one or more routes. The one or more predefined time slots may correspond to historical occurrences of a time period, such as historical occurrences of 9:00 AM to 9:30 AM, 10:00 AM to 10:30 AM, 11:45 AM to 12:00 PM, and so forth. In certain cases, the one or more predefined time slots may include different time periods of the same day or different days, or same time period of different past days.

At 604, the one or more network graphs are generated based on the plurality of historical traffic values 204A of the OD matrix 116. In an example, the network graph generation module 202B may be configured to generate the network graphs for different predefined time slots. For example, each of the network graphs corresponds to one of the one or more predefined time slots. Moreover, each of the network graphs comprise a plurality of nodes and a plurality of edges 304, such as the nodes 402 and the edges 404 depicted in FIG. 4. The edges 404 may have corresponding weight values. The nodes 402 may indicate geographical locations or zones while the edges 404 may indicate connect two nodes and indicate a travel path between two geographical locations corresponding to the two nodes. The edges 404 may have corresponding weight values indicative of traffic volume for the corresponding travel path.

At 606, one or more desired routes from the one or more routes are determined based on the weight values. Each of the one or more desired routes is associated with one of the one or more network graphs. In an example, the network graph processing module 202C is configured to determine a desired route for each of the network graphs. For example, travel time and/or traffic volume across each of the edges 404 is analyzed to identify the desired route in each of the network graphs. In an example, the desired route may be a fastest route and/or a shortest route from the other routes for each of the network graphs.

In an example, a travel time associated with the desired route is shortest among one or more travel times associated with the one or more routes other than the desired route in a corresponding network graph from the one or more network graphs. In other words, the desired route is fastest from the other routes in the network graph.

At 608, the travel frequency data 204B is determined for the desired routes at least in the one or more predefined time slots based on the network graphs. The travel frequency data 204B includes a number of trips or frequency of vehicles travelling on a link associated with an edge. Travel frequency data for a route may be based on a logical aggregation of trips along different paths or link segments forming the route.

At 610, the modal route 204C is determined based on the desired routes and the travel frequency data 204B. In an example, the modal route determination module 202D is configured to determine the modal route 204C. The modal route 204C is one of the desired routes having a highest frequency, i.e., on which more users and drivers have travelled during the predefined time slots and also other time slots of the day. In an example, same or different modal routes for different time periods of a day may be aggregated to determine fastest route pattern for the time periods of the day. Moreover, different modal routes for different source-destination pairs may be aggregated to determine the fastest route pattern for the geographic area during the particular time period of the day. Such fastest route patterns for different time periods as well as different source-destination pairs may be stored within the database 106 or the map database 114.

In an example, the processor 202 is configured to generate navigation recommendation based on the modal route 204C. In this regard, typical estimated time of arrival (ETA) from the weight values in the network graphs may be used for accurately predicting ETA of a trip of the vehicle 104 when following the modal route 204C. The modal route 204C may be used for route recommendations.

To this end, the prediction of the modal route 204C for a time period may enhance transportation infrastructure and traffic system in a geographic area. For example, a new OD matrix may be retrieved every 3 months to update or re-validate the modal route 204C of a previous cycle or epoch. The predicted modal route 204C may also be used for advisory, such as traffic monitoring and planning advisory and/or transportation network development related advisory.

Accordingly, blocks of the flowcharts 500 and 600 support combinations of means for performing the specified functions and combinations of operations for performing the specified functions. It will also be understood that one or more blocks of the flowcharts 500 and 600, and combinations of blocks in the flowcharts 500 and 600 can be implemented by special purpose hardware-based computer systems which perform the specified functions, or combinations of special purpose hardware and computer instructions.

Alternatively, the system 102 may comprise means for performing each of the operations described above. In this regard, according to an example embodiment, examples of means for performing operations may comprise, for example, the processor 202 and/or a device or circuit for executing instructions or executing an algorithm for processing information as described above.

On implementing the flowcharts 500 and 600 disclosed herein, the end result generated by the system 102 is a tangible navigation recommendation based on fastest route for vehicle.

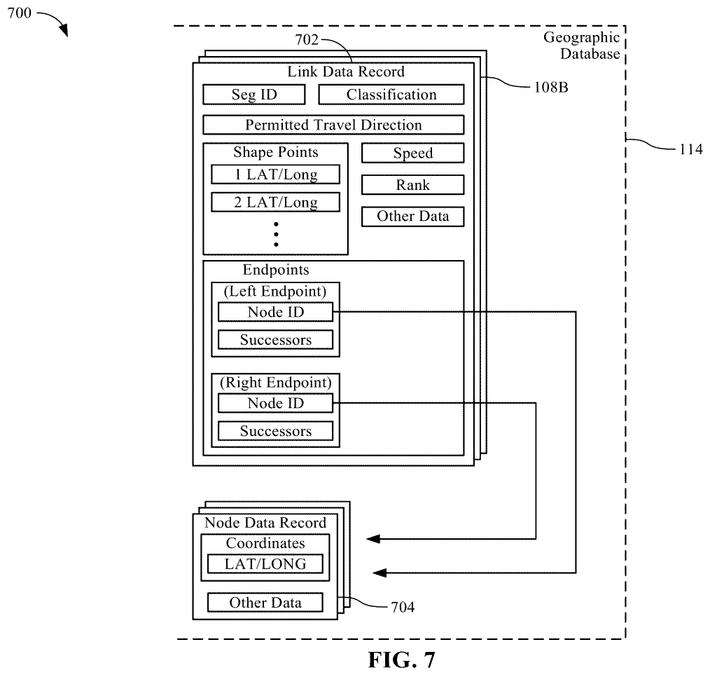

FIG. 7 shows an exemplary format of map data 700 stored in the map database 114 according to one or more example embodiments. FIG. 7 shows a link data record 702 that may be used to store data about one or more lane markings related to intersection connected links stored in the map database 114. The link data record 702 has information (such as “attributes”, “fields”, etc.) associated with it that allows identification of an intersection associated with a link and/or the geographic positions (e.g., the latitude and longitude coordinates and/or altitude or elevation) of two intersections. In addition, the link data record 702 may have information (e.g., more “attributes”, “fields”, etc.) associated with it that specify a permitted speed of travel on a portion of the road represented by the link record, a direction of travel permitted on the road portion represented by the link record, what, if any, turn restrictions exist at each of the intersections which correspond to intersections at the ends of a road portion or link represented by the link record, the street address ranges of the roadway portion represented by the link record, the name of the road, and so on. The various attributes associated with a link may be included in a single data record or are included in more than one type of records which are referenced to each other.

Each link data record that represents other-than-straight road segment may include shape point data. A shape point is a location along a link between its endpoints. To represent the shape of other-than-straight roads, the mapping platform 108 and its associated map database 114 developer selects one or more shape points along the other-than-straight road portion. Shape point data included in the link data record 702 may indicate the position, (e.g., latitude, longitude, and optionally, altitude or elevation) of the selected shape points along the represented link.

Additionally, in the compiled geographic database, such as a copy of the map database 114 that is compiled and provided to a user interface, there may also be a node data record 704 for each intersection. The node data record 704 may have associated with it information (such as “attributes”, “fields”, etc.) that allows identification of the link(s) that connect to it and/or its geographic position (e.g., its latitude, longitude, and optionally altitude or elevation).

In some embodiments, compiled geographic databases are organized to facilitate the performance of various navigation-related functions. One way to facilitate performance of navigation-related functions is to provide separate collections or subsets of the geographic data for use by specific navigation-related functions. Each such separate collection includes the data and attributes needed for performing the particular associated function but excludes data and attributes that are not needed for performing the function. Thus, the map data may be alternately stored in a format suitable for performing types of navigation functions, and further may be provided on-demand, depending on the type of navigation function.

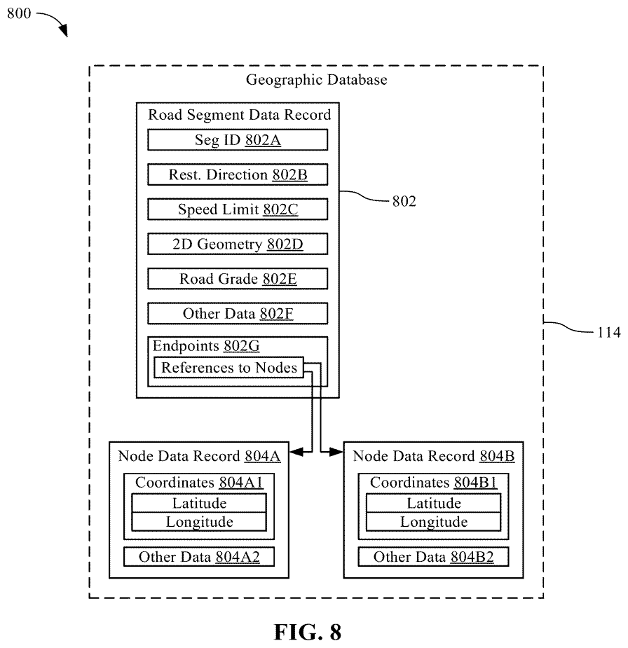

FIG. 8 shows another format of the map data 800 stored in the map database 114 according to one or more example embodiments. In the FIG. 8, the map data 800 is stored by specifying a road segment data record 802. The road segment data record 802 is configured to represent data that represents a road network. In FIG. 8, the map database 114 contains at least one road segment data record 802 (also referred to as “entity” or “entry”) for each road segment in a geographic area or region.

The map database 114 that represents a geographic area also includes a node database record (depicted as, a node data record 804A and a node data record 804B) (or “entity” or “entry”) for each intersection associated with the at least one road segment shown by the road segment data record 802. (The terms “intersection” and “segments” represent only one terminology for describing these physical geographic features and other terminology for describing these features is intended to be encompassed within the scope of these concepts). Each of the node data records 804A and 804B may have associated information (such as “attributes”, “fields”, etc.) that allows identification of the road segment(s) that connect to it and/or its geographic position (e.g., its latitude and longitude coordinates).

FIG. 8 shows some of the components of the road segment data record 802 contained in the map database 114. The road segment data record 802 includes a segment ID 802A by which the data record can be identified in the map database 114. Each road segment data record 802 has associated with it information (such as “attributes”, “fields”, etc.) that describes features of the represented road segment. The road segment data record 802 may include data 802B that indicate the restrictions, if any, on the direction of vehicular travel permitted on the represented road segment. The road segment data record 802 includes data 802C that indicates a static speed limit or speed category (i.e., a range indicating maximum permitted vehicular speed of travel) on the represented road segment. The static speed limit is a term used for speed limits with a permanent character, even if they are variable in a pre-determined way, such as dependent on the time of the day. The static speed limit is the sign posted explicit speed limit for the road segment, or the non-sign posted implicit general speed limit based on legislation.

The road segment data record 802 may also include data 802D indicating the two-dimensional (“2D”) geometry or shape of the road segment. If a road segment is straight, its shape can be represented by identifying its endpoints or intersections. However, if a road segment is other-than-straight, additional information is required to indicate the shape of the road. One way to represent the shape of an other-than-straight road segment is to use shape points. Shape points are points through which a road segment passes between its end points. By providing the latitude and longitude coordinates of one or more shape points, the shape of an other-than-straight road segment can be represented. Another way of representing other-than-straight road segment is with mathematical expressions, such as polynomial splines.

The road segment data record 802 also includes road grade data 802E that indicate the grade or slope of the road segment. In one embodiment, the road grade data 802E includes road grade change points and a corresponding percentage of grade change. Additionally, the road grade data 802E may include the corresponding percentage of grade change for both directions of a bi-directional road segment. The location of the road grade change point is represented as a position along the road segment, such as thirty feet from the end or intersection of the road segment. For example, the road segment may have an initial road grade associated with its beginning intersection. The road grade change point indicates the position on the road segment wherein the road grade or slope changes, and percentage of grade change indicates a percentage increase or decrease of the grade or slope. Each road segment may have several grade change points depending on the geometry of the road segment. In another embodiment, the road grade data 802E includes the road grade change points and an actual road grade value for the portion of the road segment after the road grade change point until the next road grade change point or end intersection. In a further embodiment, the road grade data 802E includes elevation data at the road grade change points and intersections. In an alternative embodiment, the road grade data 802E is an elevation model which may be used to determine the slope of the road segment.

The road segment data record 802 also includes data 802G providing the geographic coordinates (e.g., the latitude and longitude) of the end points of the represented road segment. In one embodiment, the data 802G are references to the node data records 804 that represent the intersection corresponding to the end points of the represented road segment.

The road segment data record 802 may also include or be associated with other data 802F that refer to various other attributes of the represented road segment. The various attributes associated with a road segment may be included in a single road segment record or may be included in more than one type of record which cross-reference each other. For example, the road segment data record 802 may include data identifying the name or names by which the represented road segment is known, the street address ranges along the represented road segment, and so on.

FIG. 8 also shows some of the components of the node data record 804A and 804B contained in the map database 114. Each of the node data records 804A and 804B may have associated information (such as “attributes”, “fields”, etc.) that allows identification of the road segment(s) that connect to it and/or its geographic position (e.g., its latitude and longitude coordinates). For the embodiment shown in FIG. 8, the node data records 804A and 804B include the latitude and longitude coordinates 804A1 and 804B1 for corresponding intersection. The node data records 804A and 804B may also include other data 804A2 and 804B2 that refer to various other attributes of the intersections. In some embodiments, the node data records 804A and 804B may be associated with at least one first point and at least one second point, which may be border points of a feature line or lane marking and at least one second line in vicinity of the feature line (or at least one first point) respectively.

Thus, the overall data stored in the map database 114 may be organized in the form of different layers for greater detail, clarity and precision. Specifically, in the case of high-definition maps, the map data may be organized, stored, sorted, and accessed in the form of three or more layers. These layers may include road level layer, lane level layer and localization layer. The data stored in the map database 114 in the formats shown in FIG. 7 and FIG. 8 may be combined in a suitable manner to provide these three or more layers of information. In some embodiments, there may be lesser or fewer number of layers of data also possible, without deviating from the scope of the present disclosure.

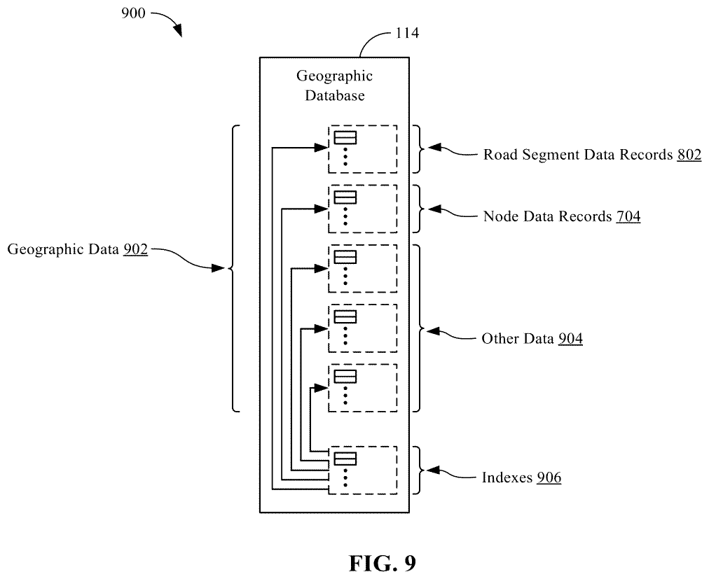

FIG. 9 illustrates a block diagram 900 of the map database 114 storing map data or geographic data 902 in the form of road segments/links, intersections, and one or more associated attributes as discussed above. Furthermore, attributes may refer to features or data layers associated with the link-intersection database, such as an HD lane data layer.

In addition, the map data 902 may also include other kinds of data 904. The other kinds of data 904 may represent other kinds of geographic features or anything else. The other kinds of data 904 may include point of interest data. For example, the point of interest data may include point of interest records comprising a type (e.g., the type of point of interest, such as restaurant, hotel, city hall, police station, historical marker, ATM, golf course, etc.), location of the point of interest, a phone number, hours of operation, etc. The map database 114 also includes indexes 906. Indices 906 may include several types of indexes that relate the distinct types of data to each other or that relate to other aspects of the data contained in the geographic database 116.

The data stored in the map database 114 in the various formats discussed above may help in providing precise data for high-definition mapping applications, autonomous vehicle navigation and guidance, cruise control using ADAS, direction control using accurate vehicle maneuvering and other such services. In some embodiments, the system 102 accesses the map database 114 storing data in the form of various layers and formats depicted in FIGS. 7-9, to retrieve map data or information from the map database 114. The system 102 may retrieve sensor data, traffic-related information and other information relating to road segments and link topology and geometry.

Returning to FIG. 1, the communication network 110 may be wired, wireless, or any combination of wired and wireless communication networks, such as cellular, Wi-Fi, internet, local area networks, or the like. In some embodiments, the communication network 110 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

In an example, the system 102 may be embodied as a cloud-based service, a cloud-based application, a cloud-based platform, a remote server-based service, a remote server-based application, a remote server-based platform, or a virtual computing system. In another example, the system 102 may be an OEM (Original Equipment Manufacturer) cloud. The OEM cloud may be configured to anonymize any data received by the system 102, before using the data for further processing, such as before sending the data to map database 114. In an example, anonymization of the data may be done by the mapping platform 108.

The mapping platform 108 may comprise suitable logic, circuitry, and interfaces that may be configured to store and process information. The mapping platform 108 may also be configured to store and update data within the map database 114. The mapping platform 108 may include or may be configured to perform techniques related to, but not limited to, geocoding, routing (multimodal, intermodal, and unimodal), clustering algorithms, machine learning in location-based solutions, natural language processing algorithms, and artificial intelligence algorithms. Data for different modules of the mapping platform 108 may be collected using a plurality of technologies including, but not limited to drones, sensors, connected cars, cameras, probes, and chipsets. In some embodiments, the mapping platform 108 may be embodied as a chip or chip set. In other words, the mapping platform 108 may comprise one or more physical packages (such as, chips) that includes materials, components and/or wires on a structural assembly (such as, a baseboard).

In some example embodiments, the mapping platform 108 may include the processing server 112 for conducting the processing functions associated with the mapping platform 108 and the map database 114 for storing map data and other information. In an example, the map database 114 may store information relating to geographic areas. In an embodiment, the processing server 112 may comprise one or more processors configured to process requests received from the system 102. The processors may fetch data from the map database 114 and transmit the same to the system 102 in a format suitable for use by the system 102. The historical traffic values 204A and the travel frequency data 204B may be collected from any sensor or database that may inform the mapping platform 108 or the map database 120 of real-time traffic on the routes during historical occurrences of the time period of the day. For example, motion sensors, inertia sensors, image capture sensors, proximity sensors, LIDAR (light detection and ranging) sensors, and ultrasonic sensors may be used to collect the historical traffic values 204A and the travel frequency data 204B. In some example embodiments, as disclosed in conjunction with the various embodiments disclosed herein, the system 102 may be used to process the historical traffic values 204A and the travel frequency data 204B for determining the modal route 204C for the vehicle 104 travelling from the source location to the destination location.

In some example embodiments, the map database 120 may also be configured to receive, store, and transmit other sensor data and probe data including positional, speed, and temporal data received from vehicles, such as the vehicle 104. In accordance with an embodiment, the probe data may include, but is not limited to, real time speed (or individual probe speed), incident data, geolocation data, timestamp data, and historical pattern data.

The map database 120 may further be configured to store object-related data and topology and geometry-related data for a route network and/or road network as map data. The map data may also include cartographic data, routing data, and maneuvering data.

For example, the data stored in the map database 120 may be compiled (such as into a platform specification format (PSF)) to organize and/or get processed for generating navigation recommendations. The navigation recommendations may include navigation instructions based on the modal route 204C. The compilation to produce the end user databases may be performed by a party or entity separate from the map developer. For example, a customer of the map developer, such as a navigation device developer or other end user device developer, may perform compilation on a received database in a delivery format to produce one or more compiled navigation databases.

The various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present disclosure. Thus, use of any such terms should not be taken to limit the spirit and scope of embodiments of the present disclosure.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

Many modifications and other embodiments of the present disclosure set forth herein will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system comprising:
a memory configured to store computer executable instructions; and
one or more processors configured to execute the instructions to:
obtain an origin-destination (OD) matrix associated with one or more routes, the OD matrix comprising a plurality of historical traffic values for one or more predefined time slots for each of the one or more routes;
generate one or more network graphs based on the plurality of historical traffic values of the OD matrix, wherein each of the one or more network graphs corresponds to one of the one or more predefined time slots, and wherein each of the one or more network graphs comprises a plurality of nodes and a plurality of edges having corresponding weight values;
determine one or more desired routes from the one or more routes based on the weight values, wherein each of the one or more desired routes is associated with one of the one or more network graphs;
determine travel frequency data for each of the one or more desired routes at least in the one or more predefined time slots based on the one or more network graphs; and
determine a modal route based on the one or more desired routes and the travel frequency data.

2. The system of claim 1, wherein the one or more predefined time slots correspond to one or more historical occurrences of a predefined time period of a day.

3. The system of claim 1, wherein each of the plurality of edges of each of the one or more network graphs is associated with one of the one or more routes, and wherein the weight value of each of the plurality of edges is associated with historical traffic volume of a corresponding route from the one or more routes.

4. The system of claim 1, wherein the one or more routes lie between a source location and a destination location.

5. The system of claim 1, wherein the one or more processors are configured to:
generate a navigation recommendation based on the modal route.

6. The system of claim 5, wherein the navigation recommendation is generated in an offline manner.

7. The system of claim 1, wherein the one or more processors are configured to:
determine the one or more desired routes based on the one or more network graphs associated with the one or more predefined time slots;
determine the travel frequency data for each of the one or more desired routes; and
determine the modal route from the one or more desired routes based on an aggregation of the one or more desired routes and the corresponding travel frequency data.

8. The system of claim 1, wherein the one or more processors are configured to:
determine the one or more desired routes based on applying a shortest path function on each of the one or more network graphs.

9. The system of claim 1, wherein the one or more processors are further configured to:
predict, using a machine learning (ML) model, the modal route from the one or more desired routes for a future time slot associated with the one or more predefined time slots, wherein the ML model is trained based on a plurality of training network graphs and training trip frequency data.

10. The system of claim 1, wherein a travel time associated with each of the one or more desired routes is shortest among one or more travel times associated with the one or more routes other than the one or more desired routes in a corresponding network graph from the one or more network graphs.

11. The system of claim 1, wherein the historical traffic values comprise traffic volume distribution for each of the one or more routes during the one or more predefined time slots.

12. A method comprising:
obtaining an origin-destination (OD) matrix associated with one or more routes, the OD matrix comprising a plurality of historical traffic values for one or more predefined time slots for each of the one or more routes;
generating one or more network graphs based on the plurality of historical traffic values of the OD matrix, wherein each of the one or more network graphs corresponds to one of the one or more predefined time slots, and wherein each of the one or more network graphs comprise a plurality of nodes and a plurality of edges having corresponding weight values;
determining one or more desired routes from the one or more routes based on the weight values, wherein each of the one or more desired routes is associated with one of the one or more network graphs;
determining travel frequency data for each of the one or more desired routes at least in the one or more predefined time slots based on the one or more network graphs; and
determining a modal route based on the one or more desired routes and the travel frequency data.

13. The method of claim 12, further comprising:
generating a navigation recommendation based on the modal route.

14. The method of claim 12, further comprising:
determining the one or more desired routes based on the one or more network graphs associated with the one or more predefined time slots;
determining travel frequency data for each of the one or more desired routes; and
determining the modal route from the one or more desired routes based on an aggregation of the one or more desired routes and the corresponding travel frequency data.

15. The method of claim 12, further comprising:
determining the one or more desired routes based on applying a shortest path function on each of the one or more network graphs.

16. The method of claim 12, further comprising:
predicting, using a machine learning (ML) model, the modal route from the one or more desired routes for a future time slot associated with the one or more predefined time slots, wherein the ML model is trained based on a plurality of training network graphs and training trip frequency data.

17. The method of claim 12, wherein the one or more predefined time slots correspond to one or more historical occurrences of a predefined time period of a day.

18. The method of claim 12, wherein each of the plurality of edges of each of the one or more network graphs is associated with one of the one or more routes, and wherein the weight value of each of the plurality of edges is associated with historical traffic volume of a corresponding route from the one or more routes.

19. The method of claim 12, wherein the one or more routes lie between a source location and a destination location.

20. A computer programmable product comprising a non-transitory computer readable medium having stored thereon computer executable instructions, which when executed by one or more processors, cause the one or more processors to conduct operations comprising:
obtaining an origin-destination (OD) matrix associated with one or more routes, the OD matrix comprising a plurality of historical traffic values for one or more predefined time slots for each of the one or more routes;
generating one or more network graphs based on the plurality of historical traffic values of the OD matrix, wherein each of the one or more network graphs corresponds to one of the one or more predefined time slots, and wherein each of the one or more network graphs comprise a plurality of nodes and a plurality of edges having corresponding weight values;
determining one or more desired routes from the one or more routes based on the weight values, wherein each of the one or more desired routes is associated with one of the one or more network graphs;
determining travel frequency data for each of the one or more desired routes at least in the one or more predefined time slots based on the one or more network graphs; and
determining a modal route based on the one or more desired routes and the travel frequency data.
